(19) United States
(12) Patent Application Publication
(10) Pub. No.: US 2004/0087933 A1
(43) Pub. Date: May 6, 2004

(54) Stiff guiding catheter liner material

(76) Inventors: Jeong S. Lee, Diamond Bar, CA (US); Bruce Wilson, Temecula, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/246,295

(22) Filed: Sep. 18, 2002

(51) Int. Cl. F16L 1/00

(52) U.S. Cl. 604/532

(57) ABSTRACT

A guiding catheter for use in a body lumen having a stiff inner liner that has an uninterrupted length and is fabricated from a material such as polyimide (PI) and polyetheretherketone (PEEK) is disclosed. The inner liner is created by coating or extruding PI or PEEK on a neckable wire mandrel. A polymeric jacket is provided over the inner liner through a coating and bonding processes. A metallic braid, mesh, or lattice reinforcing member is embedded in the polymeric jacket.

### BACKGROUND OF THE INVENTION

The present invention relates to the field of intraluminal catheters, and more particularly to guiding catheters suitable for intravascular procedures such as angioplasty, stent deployment and the like.

In percutaneous transluminal coronary angioplasty (PTCA) procedures, a guiding catheter having a shaped distal section is percutaneously introduced into the patient's vasculature by a conventional “Seldinger” technique and then advanced through the patient's vasculature until the shaped distal section of the guiding catheter is adjacent to the ostium of a desired coronary artery. The proximal end of the guiding catheter, extending outside of the patient, is torqued to rotate the shaped distal section and, as the distal section rotates, it is guided into the desired coronary ostium. The distal section of the guiding catheter is shaped so as to engage a surface of the ascending aorta and thereby seat the distal end of the guiding catheter in the desired coronary ostium, and to hold the catheter in that position during the procedures when other intravascular devices, such as guidewires and balloon catheters, are being advanced through the inner lumen of the guiding catheter.

In typical PTCA or stent delivery procedures, the balloon catheter, with a guide wire disposed within an inner lumen of the balloon catheter, is advanced within the inner lumen of the guiding catheter which has been appropriately positioned with its distal tip seated within the desired coronary ostium. The guide wire is first advanced out of the distal end of the guiding catheter into the patient's coronary artery until the distal end of the guide wire crosses a lesion to be dilated or an arterial location where a stent is to be deployed. A balloon catheter is advanced into the patient's coronary anatomy over the previously introduced guide wire until the balloon on the distal portion of the balloon catheter is properly positioned across the lesion. Once properly positioned, the balloon is inflated with inflation fluid one or more times to a predetermined size so that in the case of the PTCA procedure, the stenosis is compressed against the arterial wall and the wall expanded to open up the vascular passageway. In the case of stent deployment, the balloon is inflated to expand the stent within the stenotic region where it remains in the expanded condition. After the balloon is finally deflated, blood flow resumes through the dilated artery and the dilatation catheter and the guide wire can be removed therefrom.

In addition to their use in PTCA and stent delivery procedures, guiding catheters are used to advance a variety of electrophysiology catheters and other therapeutic and diagnostic devices into coronary arteries, coronary sinus, heart chambers, neurological and other intracorporeal locations for sensing, pacing, ablation and other procedures. For example, one particularly attractive procedure for treating patients with congestive heart failure (CHF) involves introduction of a pacing lead into the patient's coronary sinus and advancing the lead until the distal end thereof is disposed within the patient's great coronary vein which continues from the end of the coronary sinus. A second pacing lead is disposed within the patient's right ventricle and both the left and right ventricle are paced by the pacing leads, resulting in greater pumping efficiencies and greater blood flow out of the heart which minimizes the effects of CHF.

Current construction of many commercially available guiding catheters include an elongated shaft of a polymeric tubular member with reinforcing strands (usually metallic or high strength polymers) within the wall of the tubular member. The strands are usually braided into reinforcing structure. The strands are for the most part unrestrained except by the braided construction and the polymeric matrix of the catheter wall.

Clinical requirements for utilizing guiding catheters to advance electrophysiology catheters and the like have resulted in an increase in the transverse dimensions of the inner lumens of guiding catheters to accommodate a greater variety of larger intracorporeal devices and a decrease in the outer transverse dimensions of the guiding catheter to present a lower profile and thereby reduce incision size in the patient. These catheter design changes have required a reduction in the thickness in the catheter wall which results in manufacturing problems with respect to constructing such a thin walled structure in high volumes. Depending on the materials utilized for the manufacture of the liners, walls, and jackets of the catheters, significant reduction in performance may be observed with corresponding decreasing wall thickness of the guiding catheters.

Polymeric materials used for the manufacture of contemporary guiding catheters must be able to comply with diverse physical requirements. For example, the proximal region of the catheter must be sufficiently rigid to enable its distal end to be maneuvered by manual manipulation of its proximal end through the tortuous anatomy of the patient's vascular structures with high resistance to kinking. On the other hand, the distal end must be sufficiently soft so that the vascular walls are not damaged when the distal end is being advanced into the body. Typically, significant torsional and axial forces are applied to the proximal end and such forces are transmitted along the catheter to its distal end to maneuver the catheter through the vein, artery or other body parts.

In order to facilitate the movement of guide wires and intracorporeal devices within the lumen of guiding catheters, the inner walls of guiding catheters are generally made of a polymeric material or a combination of such materials. Polymers such as PEBAX, urethane or nylon have been used as guiding catheter jacket materials because of their advantageous flexural modulus properties. In addition, high-density polyethylene (HDPE), PTFE, FEP or nylon, have been used for inner surface of the guiding catheter lumens due to their relatively low coefficient of friction.

Catheters have been made from many combinations of polymers. For example, a method of securing a Teflon lining to the inner walls of a braided polyethylene catheter body has been previously disclosed.

Additional examples of catheters made from combinations of various polymers include a catheter body constructed of a hydrophilic material wherein both the inside and outside surface of the catheter body is made of a lubricious surface coating such as a lubricious hydrogel surface coating. The hydrophilic material of the catheter absorbs water and becomes, in effect, part of the bloodstream and is carried along better by the bloodstream.

An intravascular catheter, wherein the tubular body is formed with an inner liner formed from a polymer having a coefficient of friction less than about 0.50, is preferably made from commercially available polytetrafluoroethylene.

A method for the manufacture of a PTCA guiding catheter includes a lamination of an inner structural polymer tube, a lubricating means disposed on the inside of the inner structural polymer tube, a reinforcing means embedded within the inner structural polymer tube, and an outer structural polymer tube. The catheter provides melt compatible materials between the inner and outer structural polymer tubes and allows the materials to be intimately fused together to provide an encapsulation of the reinforcement member.

Further details of catheters made from various combinations of polymers can be found in, for example, U.S. Pat. No. 4,806,182; U.S. Pat. No. 5,601,538; U.S. Pat. No. 5,702,373; U.S. Pat. No. 5,836,926; and U.S. Pat. No. 5,624,617, whose contents are hereby incorporated by reference.

As the wall thicknesses of guiding catheters are reduced and smaller French sizes are desired by medical practitioners, the ability to provide adequate stiffness in the proximal shaft becomes increasingly difficult. Accordingly, there is a need for novel compositions and materials for the construction of catheter jackets and liners that may accommodate the relative stringent functional requirements for guiding catheters. The present invention satisfies these and other needs.

### SUMMARY OF THE INVENTION

The present invention is generally directed to a guiding catheter having a stiff inner liner that provides improved pushability and better torque transmission. In one embodiment, the guiding catheter includes a solid, uninterrupted polymeric tubular member in the form of a stiff inner liner. The stiff inner liner preferably includes polyimide (PI) or polyetheretherketone (PEEK). More precisely, the stiff PI inner liner is preferably fabricated by coating a neckable copper wire mandrel and subsequently heating the material to cross-link the polymer. The stiff PEEK inner liner is fabricated preferably by extrusion process, and further preferably by wire coating process. The exterior of the stiff inner liner is preferably covered by a polymeric jacket that may also be created by a melt extrusion process. The jacket is fused to the stiff inner liner. The present invention guiding catheter further includes an optional reinforcing member embedded within the polymeric jacket and the inner liner.

The reinforcing member includes a plurality of braided strands or a plurality of coiled strands. The plurality of strands further include a plurality of cross point locations where the strands cross. In one embodiment, the strands are formed of a metal alloy such as stainless steel. In another embodiment, the strands are formed of a high strength polymeric material. The outer polymeric tubular member is applied to the exterior of the reinforcing member by a heat-shrinking process.

The solid polymeric tubular member forming the stiff inner liner is a single piece of tubing that is integral and without interruptions throughout its length. As such, it has no spiral cuts. By virtue of the present invention stiff PI or PEEK inner liner and fabrication of the liner on a neckable wire mandrel, ovalization in the catheter cross-sectional shape and subsequent kinking propensity are minimzed. Optionally, for PI liner to provide a base for the jacket or outer polymeric tubular member to adhere to the inner liner, the exterior of the inner liner can be thinly coated with a particular polymer, such as nylon, copolyamide, and urethane, after cross-linking.

Although the jacket or outer polymeric tubular member can be formed of a single piece of thermoplastic material, it is preferred to form the outer jacket from multiple pieces of decreasing stiffness materials in the distal direction. Such multisectional outer polymeric tubular member is thermally fused to the inner liner preferably by heat shrinking. Exemplary of various materials that can be used to form the outer polymeric tubular member include polyethylene, polyurethane, polyamide, polyvinylchloride, and blends and copolymers thereof.

An additional aspect of this invention is a method of fabricating a guiding catheter to provide improved pushability and better torque transmission. One particular embodiment of fabricating the catheter section includes providing a neckable wire mandrel and coating the mandrel with polyimide (PI) to form a solid polymeric tubular member for use as an inner liner. The excess polymeric material is preferably removed by extrusion through dies. Following the cross-linking of the polymeric material, the neckable mandrel is optionally separated from the solid polymeric tubular member. Alternatively, and preferably, a thin polymeric coating can be applied to an outer surface of the solid polymeric tubular member to provide better adhesion to outer jacket. The solid polymeric tubular member is then cut to a desired length. A reinforcing member is positioned between the outer surface of the solid polymeric tubular member or inner liner and an inner surface of the outer polymeric tubular member or jacket.

The outer polymeric tubular member or jacket is fused to the outer surface of the solid polymeric tubular member such that the reinforcing member is encapsulated or embedded therebetween. Alternatively, the inner liner while still mounted on the mandrel may be dip coated to form the jacket after the reinforcing member is wound or braided.

In one of the present invention processes, the neckable wire mandrel is coated with PI by dip-coating to create the inner liner. Alternatively, the neckable mandrel is coated with PEEK by melt extrusion. Alternatively, and less preferred, thin PEEK liner tubing is obtained by melt extrusion. The outer surface of the inner liner may be thinly coated with a polymer in order to provide a base for the outer polymeric tubular member or jacket to adhere thereto. The solid polymeric tubular member and the outer polymeric tubular member may be fused together by a heat-shrinking process to form a single composition tubular member.

One method of fabricating a guiding catheter includes braiding a plurality of strands about the exterior of the solid polymeric tubular member onto the stiff liner, wherein the reinforcing member includes a plurality of cross point locations indicating where the strands cross. The strands are formed of either a metal alloy or a high strength polymeric material. The outer polymeric tubular member is applied to the exterior of the reinforcing member by the process of heat-shrinking.

Other features and advantages of the present invention will become more apparent from the following detailed description when taken in conjunction with the accompanying exemplary drawings.

### BRIEF DESCRIPTION OF THE DRAWINGS

FIG. 1 is a side elevational view of a guiding catheter embodying features of the present invention.

FIG. 2 is a side elevational view of a neckable copper wire mandrel.

FIG. 3 is a cut-away, perspective view of an elongated proximal shaft section of the catheter shown in FIG. 1.

FIG. 4 is a cross-sectional view of the elongated proximal shaft section taken along line 4-4 of FIG. 1.

### DETAILED DESCRIPTION OF THE PREFERRED EMBODIMENTS

The present invention is directed to guiding catheter liners that provide improved pushability and better torque transmission for the catheter when used in PTCA and stent delivery procedures, for example. With a reduction in the thickness of guiding catheter walls as a result of smaller French size guiding catheters being requested, the ability to provide adequate stiffness in the catheter has become increasingly difficult. An apparatus and method for achieving a stiffer guiding catheter at smaller French sizes is disclosed herein and involves using liner materials with much higher strength and having superior mechanical properties, such as polyimide (PI) and polyetheretherketone (PEEK).

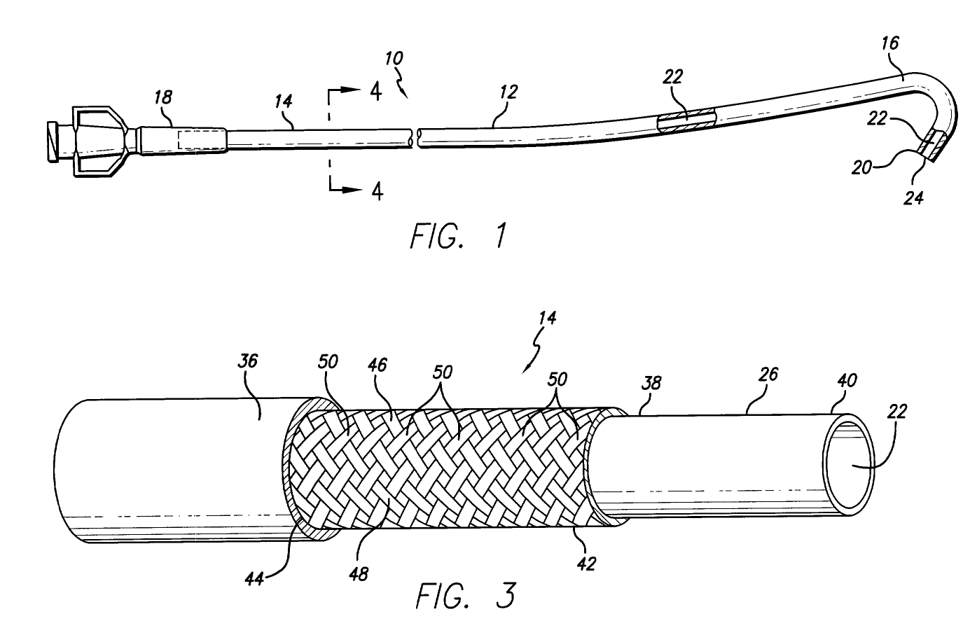

Referring now to the drawings, FIG. 1 illustrates a catheter 10 embodying features of the invention which generally includes an elongated catheter shaft 12 with a proximal shaft section 14 and a shaped distal shaft section 16, an adapter 18 mounted on a proximal end of proximal shaft section, a non-traumatic distal tip 20, and an inner lumen 22 extending therethrough the catheter shaft from the proximal end thereof to a port 24 located in the distal end of the shaft. The proximal shaft section 14 is the most stiff section of the catheter shown in FIG. 1 whereas the distal shaft section 16 has significant flexibility.

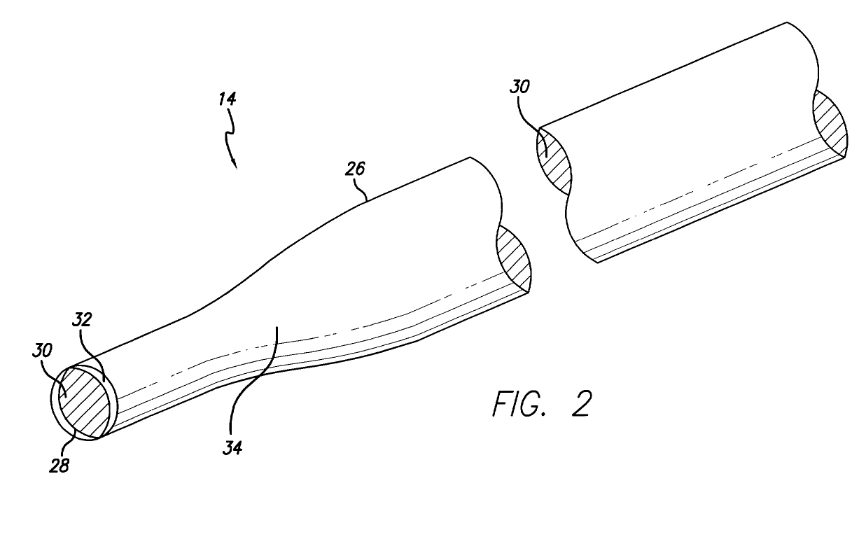

As shown in FIG. 2, the present invention includes a solid polymeric tubular member 26 embodied as a stiff inner liner 28 that is preferably fabricated from PI or PEEK. As described below, the stiff inner liner 28 is preferably fabricated by using a neckable copper wire mandrel 30 with polymeric material.

For example, the neckable copper wire mandrel is commercially available through Phelps Dodge Industries, Inc., New York, N.Y., and is made according to U.S. Pat. No. 4,659,622, issued Apr. 21, 1987, to Barta et al., titled “ESSENTIALLY LINEAR POLYMER HAVING A PLURALITY OF AMIDE, IMIDE AND ESTER GROUPS THEREIN, A TINNABLE AND SOLDERABLE MAGNET WIRE, AND A METHOD OF MAKING THE SAME,” which is commonly owned and assigned to Phelps Dodge Industries, Inc., New York, N.Y., the entirety of which is herein incorporated by reference, and U.S. Pat. No. 4,826,706, issued May 2, 1989, to Hilker et al., titled “METHOD AND APPARATUS FOR MANUFACTURING MAGNET WIRE,” which is commonly owned and commonly assigned to Phelps Dodge Industries, Inc., New York, N.Y., t he entirety of which is herein incorporated by reference. The neckable copper wire mandrel is commercially available through other vendors as well. The copper wire is then “necked” down or otherwise tapered to a smaller diameter in such manner so as to form a neckable mandrel suitable for coating with polymers.

Referring to FIG. 3, the inner liner or solid polymeric tubular member 26 has an inner surface 32 and an outer surface 34 in coaxial relationship with a jacket or outer polymeric tubular member 36. The solid polymeric tubular member 26 has a proximal end 38 and a distal end 40 and inner lumen 22 extending therethrough. A reinforcing member 42 is disposed between the outer surface of the solid polymeric tubular member 26 and an inner surface 44 of the outer polymeric tubular member 36. The outer polymeric tubular member 36 is bonded to the outer surface of the solid polymeric tubular member 26 such that the reinforcing member is encapsulated or embedded therebetween.

As shown in greater detail in FIG. 3, the proximal catheter section 14 is formed of the solid polymeric tubular member 26, an outer polymeric tubular member 36, and a braided reinforcing member 42 having multiple strands 46 disposed between the inner and outer polymeric layers. It should be appreciated that a wide variety of patterns may be utilized in accordance with the present invention.

The strands which are braided or wound to form the reinforcing member 22 may have a round (wire) or rectangular (ribbon) and their dimensions depend upon their mechanical properties and the stiffness required for the reinforcing member. For stainless steel wire, a diameter of about 0.001 to about 0.003 inch is suitable. For stainless steel ribbon, the transverse cross sectional dimensions are about 0.0005 to about 0.002 inch by about 0.003 to about 0.01 inch. The maximum wall thickness of the braided reinforcing member will be located at the cross points of the strands. The transverse and longitudinal dimensions of the catheter, the materials of construction, and the number and spacing of the reinforcing strands will vary depending upon the end use of the catheter. The strands forming the braided reinforcing member can be formed of a variety of materials including 304 stainless steel, high strength alloys, and high strength polymeric materials. High strength plastic strands (i.e., Kevlar) or mixtures of plastic and metallic strands may also be used to form the braided reinforcing structure.

Guiding catheters designed for coronary artery access generally have a length from about 90 to about 110 cm, preferably about 100 cm. The wall thickness of the catheter shaft ranges from about 0.004 to about 0.01 inch. The guiding catheter made using this invention has an inner diameter in the range of about 0.04 to about 0.10 inch and an outer diameter in the range of about 4 to about 8 French. The wall thickness of the outer polymeric tubular member 36 is about 0.001 to about 0.006 inch. The solid polymeric tubular member 26 has a wall thickness in the range of about 0.0005 to about 0.002 inch. In this two section catheter, the proximal section is the most stiff section and the distal section is the least stiff section.

The inner liner of the present invention guiding catheter made in accordance with the present invention is formed from a single piece of uninterrupted tubing of PI or PEEK. PI and PEEK materials are integral engineering polymers that possess exceptional mechanical properties. These materials are ideal for various medical applications, as described herein, where thin walls, sufficient strength and tight tolerances are essential. PI and PEEK each has a flexural modulus three to five times that of commonly used guiding catheter liner materials, such as PEBAX, urethane and PTFE. Further, PI and PEEK surfaces provide sufficient guide wire movement in comparison with traditional liner surfaces, such as HDPE, nylon, PTFE or FEP.

The stiff inner liner of the present invention, formed from the solid polymeric tubular member 26 of PI or PEEK, has an ASTM D790 flexural modulus in the range of about 430 to about 530 kpsi at about 73° F. and ASTM D638 tensile strength of at least 12,000 psi at about 73° F.

One advantage of using PI or PEEK in fabricating the inner liner of a guiding catheter is that a higher tensile strength liner material enables higher compressive forces to be applied to the catheter wall without failure (i.e., kinking) into the lumen. Further, the PI inner liner has a glass transition temperature of about 400° C. as measured by differential scanning calorimeter (DSC). Accordingly, one other advantage of using PI is that the PI inner liner has excellent dimensional stability at the processing temperature of the outer polymeric tubular member such as during heat shrinking process.

Because of the high modulus properties of a PI or PEEK inner liner, the guiding catheter has less tendency to ovalize or kink. Therefore, the inner liner need not require spiral cuts to diminish ovalization or kinking problems.

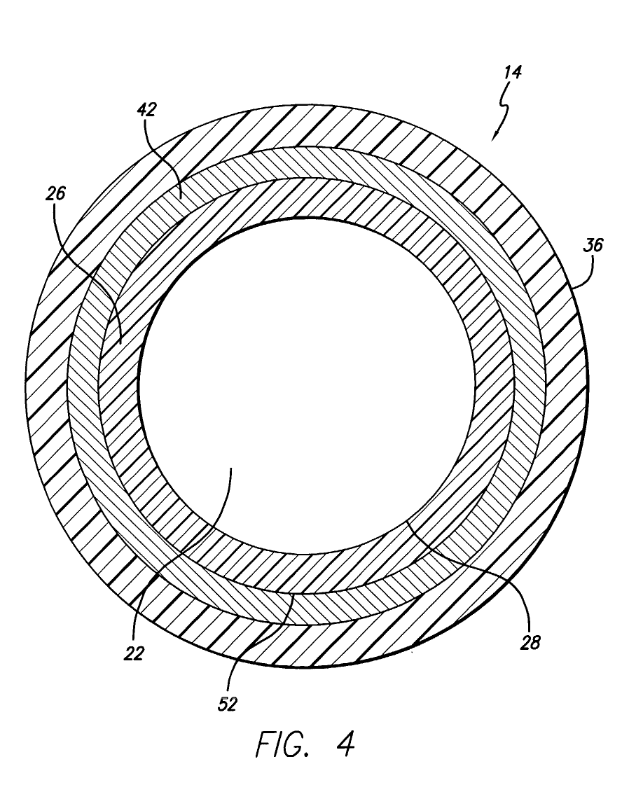

FIG. 4 illustrates a cross-sectional view of the guiding catheter 10 of the present invention. The stiff inner liner 28 formed from PI or PEEK, which material provides a lubricious surface which faces the inner lumen 22 of the guiding catheter 10 and facilitates the movement of other medical devices therethrough. The stiff inner liner of the inner liner or solid polymeric tubular member 26 has a maximum wall thickness of about 0.0015 inch. A thin coat 52 is disposed over the outer surface of the PI or PEEK solid tubular member. This thin coating is preferred to enable the solid polymeric tubular member 26 to bond to the outer polymeric tubular member 36 which is formed of a thermoplastic material. Exemplary of various coating materials that can be used include nylon, copolyamide, and urethane. The thin coating on the outer surface of the solid polymeric tubular member has a thickness in the range of about 0.0002 to about 0.0005 inch.

With further reference to FIG. 4, the outer polymeric tubular member 36 is thermally fused to the thin coating 52 on the outer surface 34 of the solid polymeric tubular member 26 by heat-shrinking, a process well known in the art. The outer polymeric tubular member is formed of a thermoplastic material. Exemplary of various materials used to form the outer polymeric tubular member include polyethylene, polyurethane, polyamide, polyvinylchloride, and blends and copolymers thereof. The outer polymeric tubular member is applied to the exterior of the reinforcing member (encapsulated therebetween the solid polymeric tubular member and the outer polymeric tubular member) by heat-shrinking, a process well known in the art.

The present invention contemplates a method for providing a guiding catheter by use of a neckable copper mandrel. The neckable copper wire mandrel 30 can be used as the core in fabricating the PI or PEEK solid tubular member 26. As set forth above, the neckable copper wire mandrel is commercially available through Phelps Dodge Industries, Inc., New York, New York. The neckable copper wire mandrel is coated with at least one of PI and PEEK polymeric material to form the solid polymeric tubular member. In one embodiment, the coating of the neckable copper wire mandrel with the PI material is by dip-coating, a process well known in the art. The thickness of the dip-coated neckable copper wire mandrel may be varied by dipping more or less of the PI material, and this thickness may be varied along the length and around the diameter of the neckable mandrel. Alternatively, the coating of the neckable mandrel with PEEK material is by melt extrusion, a process well known in the art. Once the desired thickness of the tubular member has been attained through continuous dip-coating or extrusion of the neckable copper wire mandrel with PI or PEEK material, the excess polymeric material is removed by extrusion through dies (not shown). The removal of excess polymeric material is desirable for maintaining tight tolerances of the newly formed solid polymeric tubular member.

Following the removal of the excess polymeric material with dies, PI is cross-linked or cured through heat treatment or baking. The solid polymeric tubular member 26 includes proximal and distal ends, 38 and 40, respectively, and an inner lumen 22 extending therethrough (FIGS. 1 and 3). The solid polymeric tubular member may be cut to a desired length as necessary.

Once the solid polymeric tubular member has been cut to an appropriate length, the inner lumen of the tubular member is optionally flushed out. The solid polymeric tubular member consists of an inner surface 32 and an outer surface 34 in coaxial relationship with an outer polymeric tubular member 36 (FIGS. 3-4). A reinforcing member is positioned between the outer surface of the solid polymeric tubular member and an inner surface 44 (FIG. 4) of the outer polymeric tubular member. After the reinforcing member has been properly positioned in between the solid polymeric tubular member and the outer polymeric tubular member, the outer polymeric tubular member is fused to the outer surface of the solid polymeric tubular member such that the reinforcing member is encapsulated or embedded therebetween.

The use of a neckable copper wire mandrel such as the one available through vendor Phelps Dodge, Inc., enables the solid polymeric tubular member to attain a degree of ovality of nearly zero. The term “ovality” can be defined as the major axis-minor axis in a typical oval-shaped axis. In fabricating the PI or PEEK tubular member of the present invention, it is desirable to reach a degree of ovality of zero. Accordingly, the degree of the newly formed polymeric tubular member being oval is much less because the tubular member is supported by the neckable mandrel during its formation throughout the continuous dip-coating or melt extrusion process. The polymeric tubular member is obtained after removal of the neckable mandrel. It should be appreciated that a neckable mandrel other than copper wire may be used to form the polymeric tubular member. A new mandrel may be inserted for braiding.

In one embodiment, the outer surface of the PI or PEEK tubular member is thinly coated with an additional polymer material. The thin coating disposed on the solid polymeric tubular member helps the solid polymeric tubular member to bond to the outer polymeric tubular member, a single piece of thermoplastic material. Exemplary of various coating materials that can be used include nylon, copolyamide, and urethane. The thin coating on the outer surface of the solid polymeric tubular member has a thickness in the range of about 0.0002 to about 0.0005 inch.

In another embodiment, the outer polymeric tubular member is fused to the solid polymeric tubular member by heat-shrinking, a process well known in the art. Various materials that form the outer polymeric tubular member include polyethylene, polyurethane, polyamide, polyvinylchloride and blends and copolymers thereof.

With regard to the fabrication of the reinforcing member, a plurality of strands are braided about the exterior of the solid polymeric tubular member such that the reinforcing member includes a plurality of cross point locations indicating the point at which the strands cross. The well known process of heat shrinking is also used to apply the outer polymeric tubular member to the exterior of the reinforcing member.

It should be appreciated that the guiding catheter of the present invention also contemplates the use of radiopaque fillers (i.e., platinum, tungsten, bismuth or barium or their compounds) incorporated into the design of at least one of the solid polymeric tubular member 26 and the outer polymer tubular member 36. The presence of radiopaque material within the solid polymeric tubular member or the outer polymeric tubular member allows the physician to track under fluoroscopy the navigation of the guiding catheter through the tortuous vessels of the patient's body lumen.

It will be apparent from the foregoing that, while particular forms of the invention have been illustrated and described, various modifications can be made without departing from the spirit and scope of the invention. Moreover, those skilled in the art will recognize that features shown in one embodiment of the invention may be utilized in other embodiments of the invention.

What is claimed is:

1. A guiding catheter for use in a body lumen, comprising:
a stiff, inner liner made of a tubular material uninterrupted along its length that is selected from a group of polymers consisting of polyimide (PI) or polyetheretherketone (PEEK);
a polymeric jacket bonded to an exterior of the inner liner; and
a reinforcing member disposed overlying the inner liner and embedded within the polymeric jacket.

2. The guiding catheter of claim 1, wherein the inner liner is fabricated by disposing PI on a neckable copper wire mandrel, and coating PI with a polymeric material.

3. The guiding catheter of claim 1, wherein the inner liner is fabricated by extruding PEEK.

4. The guiding catheter of claim 3, wherein PEEK is extruded on a neckable mandrel.

5. The guiding catheter of claim 1, wherein the inner liner includes a flexural modulus in the range of about 430 to about 530 kpsi at about 73° F. and a tensile strength of at least 12,000 psi at about 73° F.

6. The guiding catheter of claim 1, wherein the inner liner includes a maximum wall thickness of about 0.0015 inch.

7. The guiding catheter of claim 1, wherein an exterior of the PI inner liner includes a thin coating of a polymer selected from the group consisting of nylon, copolyamide, or urethane.

8. The guiding catheter of claim 7, wherein the coating on the exterior of the PI inner liner includes a thickness in the range of about 0.0002 to about 0.0005 inch.

9. The guiding catheter of claim 7, wherein the coating on the exterior of the PI inner liner is thermally fused to the outer polymeric jacket by heat-shrinking.

10. The guiding catheter of claim 7, wherein the PI stiff inner liner includes a DSC glass transition temperature of about 400° C.

11. The guiding catheter of claim 1, wherein an exterior of the PEEK inner liner includes a thin coating of a polymer selected from the group consisting of nylon, copolyamide, or urethane.

12. The guiding catheter of claim 11, wherein the coating on the exterior of the PEEK inner liner has a thickness in the range of about 0.0002 to about 0.0005 inch.

13. The guiding catheter of claim 11, wherein the coating on the exterior of the PEEK inner liner is thermally fused to the polymeric jacket by heat-shrinking.

14. The guiding catheter of claim 1, wherein tubular material of the inner liner that is uninterrupted along its length does not include spiral cuts.

15. The guiding catheter of claim 1, wherein the polymeric jacket comprises a material selected from the group consisting of polyethylene, polyurethane, polyamide, polyvinylchloride or blends and copolymers thereof.

16. The guiding catheter of claim 1, wherein the reinforcing member includes at least one of a plurality of braided strands or a plurality of coiled strands.

17. A method of fabricating a guiding catheter for use in a body lumen, comprising:
providing a neckable wire mandrel;
coating the neckable wire mandrel with polyimide (PI) to form a tubular inner liner that is uninterrupted along its length;
extruding the tubular inner liner through at least one die to remove excess polymeric material;
cross-linking the polymeric material;
separating the neckable wire mandrel from the tubular inner liner;
flushing an inner lumen of the tubular inner liner;
disposing a reinforcing member overlying an exterior of the tubular inner liner;
coating an exterior of the tubular inner liner with a polymer to create a jacket; and
bonding the polymeric jacket to the tubular inner liner to embed the reinforcing member therebetween.

18. The method of claim 17, wherein the tubular inner liner does not include spiral cuts.

19. The method of claim 17, wherein the coating of the neckable wire mandrel includes dip-coating.

20. The method of claim 17, wherein the method includes heat shrinking polymeric jacket to the tubular inner lining.

21. A method for providing a guiding catheter for use in a body lumen, comprising:
providing a stiff, inner liner made of a tubular material uninterrupted along its length that is selected from a group of polymers consisting of polyimide (PI) or polyetheretherketone (PEEK);
providing a polymeric jacket;
bonding the polymer jacket to an exterior of the inner liner;
providing a reinforcing member overlying the inner liner; and
embedding the reinforcing member within the polymeric jacket.

22. The method of claim 21, wherein the method further comprises providing a neckable mandrel, coating the mandrel to create the inner liner, and coating the inner liner to create the polymeric jacket.
